(19) United States
(12) Patent Application Publication
(10) Pub. No.: US 2026/0208399 A1
(43) Pub. Date: Jul. 23, 2026

(54) MOLD PRODUCTION METHOD AND MOLD PRODUCTION DEVICE

(71) Applicant: Dexerials Corporation, Shimotsuke-shi, Tochigi (JP)

(72) Inventors: Kazuhiko NODA, Shimotsuke-shi, Tochigi (JP); Junichi SASAKI, Shimotsuke-shi, Tochigi (JP); Kyoko SAKURAI, Shimotsuke-shi, Tochigi (JP)

(73) Assignee: Dexerials Corporation, Shimotsuke-shi, Tochigi (JP)

(21) Appl. No.: 19/135,797

(22) PCT Filed: Oct. 13, 2023
(86) PCT No.: PCT/JP2023/037288

§ 371 Date: Jun. 5, 2025

(30) Foreign Application Priority Data
Dec. 8, 2022 (JP) 2022-196653

(51) Int. Cl. B29C 33/38; B29C 59/04; B29L 11/00

(52) U.S. Cl. CPC B29C 33/3842; B29C 59/04; B29C 2793/0009; B29L 2011/0016

(57) ABSTRACT

A mold production method includes a signal generation step of generating a gradation signal corresponding to each cutting hole configuring a drawing target on a mold base material, a control waveform generation step of generating, based on the gradation signals corresponding to the cutting holes, a control waveform indicating a movement pattern of a cutting blade (12), and a cutting step of moving the cutting blade (12) according to the control waveform to cut the mold base material. In the control waveform generation step, a control waveform is generated for each group of cutting holes not overlapping each other among cutting holes aligned in one direction, based on the gradation signals corresponding to the cutting holes constituting each group, and in the cutting step, the cutting blade (12) is moved according to each control waveform generated for the groups to cut the mold base material to a predetermined depth.

### CROSS-REFERENCE TO RELATED APPLICATION

The present application claims priority to Japanese Patent Application No. 2022-196653 filed on Dec. 8, 2022, the entire contents of which are incorporated herein by reference.

### TECHNICAL FIELD

The present disclosure relates to a mold production method and a mold production device.

### BACKGROUND

Microlens arrays, in which a large number of microscopic lenses (microlenses) are arranged two-dimensionally, are used in various applications such as diffusion plates, diffusion sheets, or screens for head-up displays. One method of producing microlens arrays with high mass productivity is to form a pattern of the inverse shape of the reference pattern of the microlens array (hereinafter referred to as the “transfer pattern”) on the mold surface, transfer the transfer pattern formed on the mold surface onto a resin coated on a substrate, and cure the resin after transfer. The desired microlens array can be produced by cutting the resin after curing as necessary.

In the method described above, a roll mold having the transfer pattern formed on the surface of a cylindrical or columnar roll is used, and the Roll to Roll method is used to produce microlens arrays with high mass productivity and high uniformity of quality.

One method of producing the roll mold described above is to cut the surface of a cylindrical or columnar roll (mold base material) with a cutting blade to form the transfer pattern on the roll. For example, Patent Literature (PTL) 1 describes a technique for cutting the roll surface by causing the cutting blade to reciprocate in the radial direction of the roll while rotating the roll.

### CITATION LIST

### Patent Literature

PTL 1: JP 2012-013748 A

### SUMMARY

### Technical Problem

In the above-described molds used for purposes such as producing microlens arrays, cutting holes 100 may be formed so as to partially overlap, as illustrated in FIG. 13A. In FIG. 13A, an example is illustrated in which the cutting holes 100 have an elliptical shape in plan view. The plurality of cutting holes 100 illustrated in FIG. 13A is cut by, for example, moving the cutting blade relative to the cutting surface of the mold base material in one direction (upward on the paper in FIG. 13A) while causing the cutting blade to reciprocate in the perpendicular direction with respect to the mold base material, and repeating this process in a direction (horizontally on the paper in FIG. 13A) orthogonal to the one direction (cutting direction).

FIG. 13B is a cross-sectional view along the A-A′ line illustrated in FIG. 13A. In FIG. 13B, the outlines of the recesses corresponding to each of the plurality of cutting holes 100 are illustrated as dotted lines. As illustrated in FIG. 13B, the outlines (dashed dotted lines) of the recesses corresponding to each of the overlapping cutting holes 100 are arranged to intersect. By moving the cutting blade relative to the mold base material along a cutting trajectory (dashed double-dotted line in FIG. 13B) that follows the outlines, a plurality of cutting holes 100 that partially overlap each other can be formed in the mold base material.

When forming partially overlapping cutting holes 100 as illustrated in FIG. 13B, it is necessary to switch the outline along which the cutting blade is moved at the intersection between the outline of the recess corresponding to one cutting hole 100 and the outline of the recess corresponding to another cutting hole 100 that overlaps the one cutting hole 100. Such switching yields an inflection point in the cutting trajectory at the intersection between the outline of the recess corresponding to the one cutting hole 100 and the outline of the recess corresponding to the other cutting hole 100 that overlaps the one cutting hole 100, as illustrated in FIG. 13B. The tracking ability of the FTS (Fast Tool Servo), which causes the cutting blade to reciprocate relative to the mold base material, degrades upon the occurrence of such an inflection point, and the surface of the cut mold becomes more susceptible to shape abnormalities such as protrusions called burrs, or surface accuracy abnormalities called chatter, caused by vibration of the FTS. It is known that shape abnormalities in a mold can, for example, adversely affect the optical characteristics of the microlens arrays produced using the mold.

In FIGS. 13A and 13B, the example of cutting holes 100 having an elliptical shape in plan view has been used as an example, but the cutting holes 100 are not limited to this shape. In short, the same problem occurs when cutting holes 100 partially overlap each other.

It is an aim of the present disclosure, made in view of the aforementioned problems, to provide a mold production method and mold production device capable of producing a mold in which a plurality of cutting holes arranged along the cutting direction and partially overlapping each other is cut in the mold base material with higher precision.

### Solution to Problem

A mold production method according to one embodiment is a mold production method using a mold production device comprising a cutting blade capable of reciprocating in a direction perpendicular to a mold base material and capable of moving relatively in at least one direction along a cutting surface of the mold base material, the mold production method including a signal generation step of generating a gradation signal corresponding to each cutting hole in a plurality of cutting holes configuring a drawing target on the mold base material, the gradation signal indicating an arrangement and a depth of the cutting hole, a control waveform generation step of generating, based on gradation signals corresponding to the cutting holes, a control waveform indicating a movement pattern of the cutting blade to cause the cutting blade to reciprocate at cutting points of the cutting holes, and a cutting step of moving the cutting blade according to the control waveform to cut the mold base material, wherein each cutting hole in a plurality of cutting holes aligned in the one direction is arranged to partially overlap with one or more other cutting holes, in the control waveform generation step, a control waveform is generated for each group in a plurality of groups of cutting holes that do not overlap each other among the plurality of cutting holes aligned in the one direction, based on gradation signals corresponding to the cutting holes constituting each group, and in the cutting step, the cutting blade is moved according to each control waveform in a plurality of control waveforms generated for the groups to cut the mold base material to a predetermined depth.

In the mold production method according to an embodiment, in the cutting step, cutting of the mold base material according to each control waveform in the plurality of control waveforms is repeated until reaching the depth indicated by the gradation signal corresponding to each cutting hole in the plurality of cutting holes aligned in the one direction.

In the mold production method according to an embodiment, the mold base material is columnar or cylindrical and is held in a circumferentially rotatable manner.

In the mold production method according to an embodiment, the cutting hole has a spherical shape, an aspherical shape, or a substantially rectangular shape.

A mold production device according to one embodiment includes a cutting blade capable of reciprocating in a direction perpendicular to a mold base material and capable of moving relatively in at least one direction along a cutting surface of the mold base material, a signal generator configured to generate a gradation signal corresponding to each cutting hole in a plurality of cutting holes configuring a drawing target on the mold base material, the gradation signal indicating an arrangement and a depth of the cutting hole, and generate, based on gradation signals corresponding to the cutting holes, a control waveform indicating a movement pattern of the cutting blade to cause the cutting blade to reciprocate at cutting points of the cutting holes, and a controller configured to move the cutting blade according to the control waveform to cut the mold base material, wherein the signal generator is configured to generate a control waveform for each group in a plurality of groups of cutting holes that do not overlap each other among a plurality of cutting holes aligned in the one direction, based on gradation signals corresponding to the cutting holes constituting each group, and the controller is configured to move the cutting blade according to each control waveform in a plurality of control waveforms generated for the groups to cut the mold base material to a predetermined depth.

### Advantageous Effect

According to the present disclosure, it is possible to provide a mold production method and mold production device capable of producing a mold in which a plurality of cutting holes arranged along the cutting direction and partially overlapping each other is cut in the mold base material with higher precision.

### BRIEF DESCRIPTION OF THE DRAWINGS

In the accompanying drawings:

FIG. 1 is a diagram illustrating an example configuration of a roll mold production device according to an embodiment of the present disclosure;

FIG. 2A is a diagram illustrating an example of the cutting blade illustrated in FIG. 1 and is a front view of the cutting blade;

FIG. 2B is a side view of the cutting blade illustrated in FIG. 1;

FIG. 3 is a diagram illustrating an example of the generation of control waveforms by the signal generator illustrated in FIG. 1;

FIG. 4 is a diagram illustrating the arrangement of cutting holes and an example of control signals generated by the signal generator illustrated in FIG. 1;

FIG. 5 is a diagram illustrating cutting by the controller illustrated in FIG. 1;

FIG. 6 is a flowchart illustrating an example of operations of the mold production device illustrated in FIG. 1;

FIG. 7A is a diagram illustrating the control waveform and the vibration generated in the mold base material in the case of continuously cutting the cutting holes that overlap each other;

FIG. 7B is a diagram illustrating the control waveform and the vibration generated in the mold base material in the case of not continuously cutting the cutting holes that overlap each other;

FIG. 7C is an SEM image of the surface of the mold base material cut according to the control waveform illustrated in FIG. 7A;

FIG. 7D is an SEM image of the surface of the mold base material cut according to the control waveform illustrated in FIG. 7B;

FIG. 8 is a flowchart illustrating a specific example of operations of the mold production device illustrated in FIG. 1;

FIG. 9 is a flowchart illustrating the details of cutting the mold base material according to the control waveform;

FIG. 10A is a diagram illustrating the arrangement pattern of cutting holes according to Example 1 of the present disclosure;

FIG. 10B is a diagram illustrating the arrangement pattern of cutting holes according to Example 2 of the present disclosure;

FIG. 10C is a diagram illustrating the arrangement pattern of cutting holes according to Example 3 of the present disclosure;

FIG. 11A is an image of the surface of a mold according to Example 1 of the present disclosure;

FIG. 11B is an image of the surface of a mold according to Example 2 of the present disclosure;

FIG. 11C is an image of the surface of a mold according to Example 3 of the present disclosure;

FIG. 11D is an image of the surface of a mold according to Comparative Example 1 of the present disclosure;

FIG. 12A is an SEM image of the surface of a microlens array produced using the mold according to Example 1 of the present disclosure;

FIG. 12B is an SEM image of the surface of a microlens array produced using the mold according to Example 2 of the present disclosure;

FIG. 12C is an SEM image of the surface of a microlens array produced using the mold according to Example 3 of the present disclosure;

FIG. 12D is an SEM image of the surface of a microlens array produced using the mold according to Comparative Example 1 of the present disclosure;

FIG. 13A is a diagram illustrating an example arrangement pattern of a plurality of cutting holes; and

FIG. 13B is a diagram illustrating an example cutting pattern of the cutting holes in FIG. 13A.

### DETAILED DESCRIPTION

Embodiments of the present disclosure are described below with reference to the drawings. Identical reference signs in the drawings indicate identical or similar constituent elements.

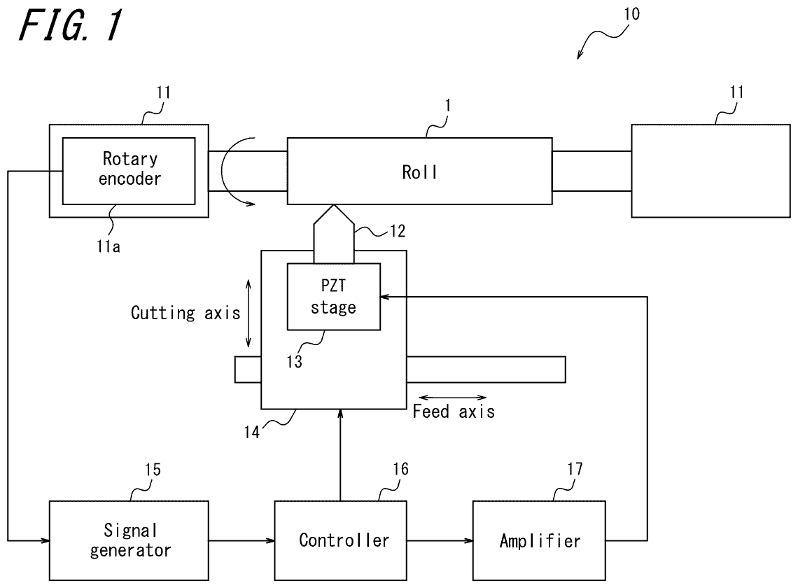

FIG. 1 illustrates an example configuration of a mold production device 10 according to one embodiment of the present disclosure. The mold production device 10 according to the present embodiment is a production device that produces a mold (roll mold) by cutting a cylindrical or columnar roll 1, which is the mold base material, at any cutting point to any depth, according to a drawing target. In the present embodiment, an example in which the mold base material is a cylindrical or columnar roll 1 is used, but the present disclosure is not limited to this example, and the mold base material may, for example, be a flat plate.

As illustrated in FIG. 1, the mold production device 10 according to the present embodiment includes a rotation device 11, a cutting blade 12, a PZT stage 13, a cutting tool stage 14, a signal generator 15, a controller 16, and an amplifier 17.

The rotation device 11 supports the cylindrical or columnar roll 1 from the axial direction and rotates the roll 1 in the circumferential direction. The roll 1 is configured to have metal, such as SUS (Steel Use Stainless), as the base material. The surface of the roll 1 is plated with a machinable material such as Ni—P or Cu. The roll 1 is not limited to being plated and may be a machinable material such as pure copper or aluminum. The rotation device 11 includes a rotary encoder 11a.

The rotary encoder 11a outputs signals corresponding to the rotational position of the roll 1 to the signal generator 15. The signals according to the rotational position of the roll 1 include a trigger signal that is outputted each time the rotational position of the roll 1 reaches a predetermined reference position in one rotation and a pulse signal that is outputted each time the roll 1 rotates by a predetermined amount.

The cutting blade 12 is a cutting tool that cuts the roll 1. The cutting blade 12 is made of a hard material, such as a ceramic tip, diamond tip, or carbide tip.

The PZT stage 13 holds the cutting blade 12. The PZT stage 13 includes a PZT (lead zirconate titanate) piezoelectric element, and the PZT piezoelectric element expands and contracts in response to the voltage level of a drive signal, thereby causing the cutting blade 12 to reciprocate in the radial direction of the roll 1. Therefore, the cutting blade 12 can reciprocate in the radial direction of the roll 1 via the PZT stage 13. The drive means for driving the cutting blade 12 is not limited to a PZT piezoelectric element.

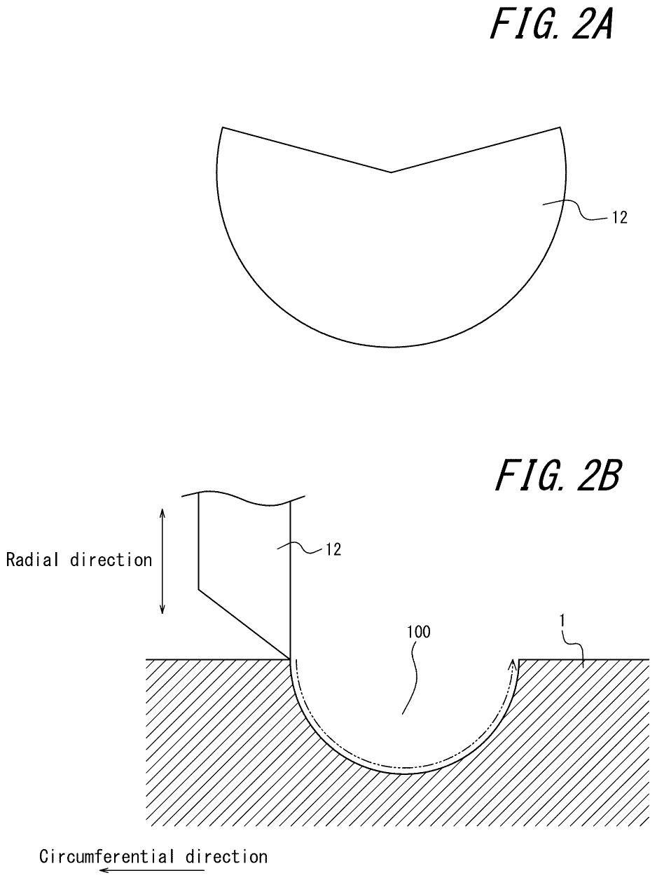

FIG. 2A is a diagram illustrating an example of the cutting blade 12 and is a front view of the cutting blade 12. FIG. 2B is a side view of the cutting blade 12 illustrated in FIG. 2A.

In the example illustrated in FIG. 2A, the cutting blade 12 has a circular shape. The cutting blade 12 is positioned so that the front face of the cutting blade 12 faces the circumferential direction of the roll 1. As described above, the roll 1 rotates in the circumferential direction. By causing the cutting blade 12 to reciprocate in the radial direction of the roll 1 towards the rotating roll 1, the cutting blade 12 appears moves in a semicircular shape as illustrated by the dashed arrow in FIG. 2B. The bottom surface of the cutting hole 100 (concave portion of the roll 1) becomes curved due to cutting by the cutting blade 12 that reciprocates in the radial direction of the circumferentially rotating roll 1. Specifically, the cutting hole 100 has a circular bottom surface with the same curvature as that of the circular portion of the cutting blade 12. In other words, the cutting blade 12 can reciprocate in a direction perpendicular to the mold base material (in the radial direction of the roll 1) and can also move relatively in at least one direction (the circumferential direction of the roll 1) along the cutting surface of the mold base material. The cutting blade 12 with this configuration can form a cutting hole 100 along one direction of the cutting surface of the roll 1 (mold base material).

In FIG. 2A, the cutting blade 12 has been described as having a circular shape, but the cutting blade 12 is not limited to this example. The cutting blade 12 may, for example, have a tip in the shape of a cone, pyramid, or the like. The cutting blade 12 may also be in the shape of a truncated cone tapered toward the tip.

In FIG. 2B, the cutting blade 12 has been described as apparently moving in a semicircular shape, but this example is not limiting. The cutting blade 12 may, for example, appear to move in a trapezoidal or triangular shape when the cutting blade 12 is viewed from the side. By varying the shape of the cutting blade 12 and the trajectory of the apparent movement of the cutting blade 12 (cutting trajectory), cutting holes 100 whose openings have various shapes can be formed. By adjusting the shape and cutting trajectory of the cutting blade 12, cutting holes 100 with various shapes, such as a spherical shape, an aspherical shape, or a substantially rectangular shape, can be formed.

Referring again to FIG. 1, the cutting tool stage 14 holds the PZT stage 13 and moves in a cutting axis direction (radial direction of the roll 1) and a feed axis direction (axial direction of the roll 1). As the cutting tool stage 14 moves, the PZT stage 13 and cutting blade 12 held by the cutting tool stage 14 also move in the cutting axis direction and the feed axis direction. While the roll 1 is rotated, the cutting blade 12 is caused to reciprocate in the radial direction of the roll 1 by the PZT stage 13 to cut the roll 1, and the PZT stage 13 is moved in the radial and axial directions of the roll 1, thereby forming cutting holes 100 over the entire surface of the roll 1.

Drawing data representing the drawing target is inputted to the signal generator 15. Based on the inputted drawing data, the signal generator 15 generates gradation signals that represent the drawing target by the arrangement of the plurality of cutting holes 100 cut in the roll 1 and the depth of the plurality of cutting holes 100. The drawing data is, for example, data on the unevenness pattern to be transferred to the transfer object. The drawing data may also, for example, be data on an image to be printed on printed material. Based on the inputted drawing data, the signal generator 15 generates a gradation signal corresponding to each cutting hole 100 in the plurality of cutting holes 100, the gradation signal indicating the arrangement and the depth of the cutting hole 100. For example, the signal generator 15 generates the gradation signal to indicate eight levels of depth.

Based on the gradation signals, the signal generator 15 generates a control waveform that indicates the movement pattern of the cutting blade 12. Specifically, the signal generator 15 generates a control waveform indicating a movement pattern to move the cutting blade 12 in the radial direction of the roll 1 so that the roll 1 is cut according to the arrangement of the cutting holes 100 and the depth of the cutting holes 100 indicated in the gradation signals.

Based on the signal outputted from the rotary encoder 11a, the signal generator 15 determines the cutting points of the roll 1 corresponding to the arrangement of the cutting holes 100 indicated by the gradation signals. The signal generator 15 then generates a control waveform indicating a movement pattern of the cutting blade 12 to cause the cutting blade 12 to reciprocate at the determined cutting points of the cutting holes 100.

The generation of control waveforms by the signal generator 15 is described in more detail.

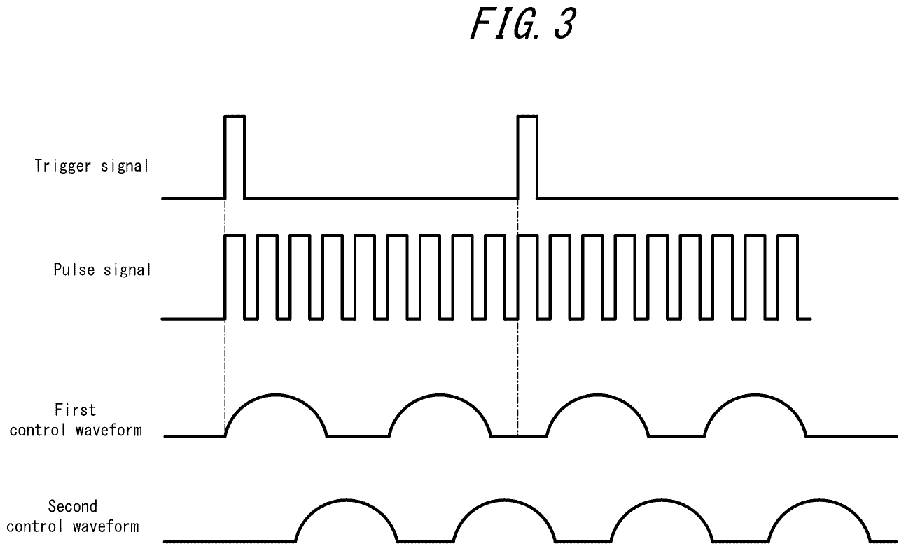

As described above, the rotary encoder 11a outputs a trigger signal each time the rotational position of the roll 1 reaches a predetermined reference position in one rotation. Specifically, as illustrated in FIG. 3, for example, the rotary encoder 11a outputs, as the trigger signal, a pulse-shaped signal that rises each time the rotational position of the roll 1 reaches a predetermined reference position in one rotation. Also, as illustrated in FIG. 3, the rotary encoder 11a outputs, as a pulse signal, a pulse-shaped signal that rises each time the roll 1 rotates by a predetermined amount. For example, the rotary encoder 11a outputs, as the pulse signal, a pulse-shaped signal that rises upon each rotation amount obtained by dividing one rotation of the roll 1 by 1.44 million.

The trigger signal and the pulse signal outputted by the rotary encoder 11a are inputted to the signal generator 15. The signal generator 15 counts the pulse signals based on the output timing of the trigger signal (timing when the trigger signal rises). The signal generator 15 then generates the control waveform according to the pulse signal count. By counting the pulse signals with reference to the output timing of the trigger signal, the signal generator 15 can identify the rotational position of the roll 1 from a predetermined reference position. Therefore, the signal generator 15 can generate a control waveform indicating the movement pattern of the cutting blade 12 to cause the cutting blade 12 to reciprocate in the radial direction of the roll 1 at the cutting points of the roll 1 corresponding to the arrangement of the plurality of cutting holes 100 indicated in the gradation signals.

As illustrated in FIG. 3, in the present embodiment, the signal generator 15 generates a plurality of control waveforms with different movement patterns of the cutting blade 12. In FIG. 3, an example is illustrated in which the signal generator 15 generates two control waveforms.

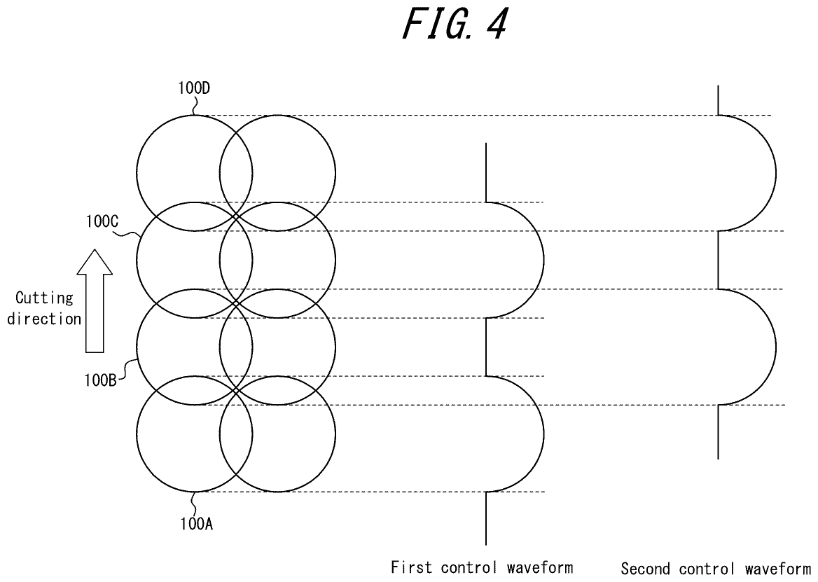

FIG. 4 illustrates an example of the arrangement of the plurality of cutting holes 100 and an example of the control waveforms generated by the signal generator 15 for cutting the plurality of cutting holes 100. As illustrated in FIG. 4, an example is described below in which the plurality of cutting holes 100 is arranged to be aligned in the cutting direction (vertically on the paper) and in a direction orthogonal to the cutting direction (horizontally on the paper), and the cutting holes 100 arranged in the cutting direction partially overlap each other. In FIG. 4, an example in which the cutting holes 100 adjacent to each other in the cutting direction partially overlap is illustrated, but more than two cutting holes 100 aligned in the cutting direction may overlap.

The signal generator 15 generates a control waveform for each group in a plurality of groups of cutting holes 100 that do not overlap each other among the plurality of cutting holes 100 (cutting holes 100A, 100B, 100C, 100D) aligned in the cutting direction, based on the gradation signals corresponding to the cutting holes 100 constituting each group. In the example illustrated in FIG. 4, the signal generator 15 generates a first control waveform indicating the movement pattern of the cutting blade 12 based on the gradation signals corresponding to the cutting hole 100A and the cutting hole 100C that does not overlap with the cutting hole 100A. The signal generator 15 also generates a second control waveform indicating the movement pattern of the cutting blade 12 based on the gradation signals corresponding to the cutting hole 100B and the cutting hole 100D.

The signal generator 15 thus generates a plurality of control waveforms that cut while skipping every other cutting hole 100 aligned in the cutting direction in the example in FIG. 4, so that cutting holes 100 that overlap each other are not continuously cut. Although FIG. 4 illustrates an example in which the signal generator 15 generates control waveforms such that the cutting holes 100 aligned in the cutting direction are cut while every other cutting hole 100 is skipped, this example is not limiting. For example, if more than two cutting holes 100 aligned in the cutting direction overlap, the signal generator 15 generates control waveforms that skip the overlapping number of cutting holes 100.

Referring again to FIG. 1, the signal generator 15 outputs the generated gradation signals and control waveforms to the controller 16.

The controller 16 causes the cutting blade 12 to reciprocate in the radial direction of the roll 1 to cut the roll 1 according to the control waveforms generated by the signal generator 15. Specifically, the controller 16 generates a drive signal to drive the PZT stage 13 based on the control waveform and outputs the drive signal to the amplifier 17. The amplifier 17 amplifies the drive signal, and the PZT stage 13 is driven by the amplified drive signal. The controller 16 moves the cutting tool stage 14 in the radial and axial directions of the roll 1 according to the gradation signals so that the cutting points determined by the signal generator 15 are cut one or more times by the cutting blade 12 that reciprocates in the radial direction of the roll 1. In this way, the roll 1 is cut by the reciprocating cutting blade 12 to a predetermined depth at the predetermined cutting points according to the gradation signals. As described above, in the present embodiment, the cutting points are determined based on the signals outputted from the rotary encoder 11a, so that any cutting point can be cut more precisely to any depth according to the drawing target.

As described with reference to FIG. 4, in the present embodiment, the signal generator 15 outputs a plurality of control waveforms (in the example in FIG. 4, the first control waveform and the second control waveform). The controller 16 moves the cutting blade 12 according to one control waveform among the plurality of control waveforms to cut the roll 1 to a predetermined depth. Next, the controller 16 moves the cutting blade 12 according to another control waveform to cut the roll 1 to a predetermined depth. The controller 16 repeats the cutting until each cutting hole 100 is cut to the depth indicated by the corresponding gradation signal. In other words, the controller 16 moves the cutting blade 12 according to each control waveform in a plurality of control waveforms generated for respective groups to cut the mold base material to a predetermined depth. The controller 16 repeats the cutting of the roll 1 according to each of the plurality of control waveforms until the depth indicated by the gradation signal corresponding to each of the plurality of cutting holes 100 aligned in the cutting direction is reached.

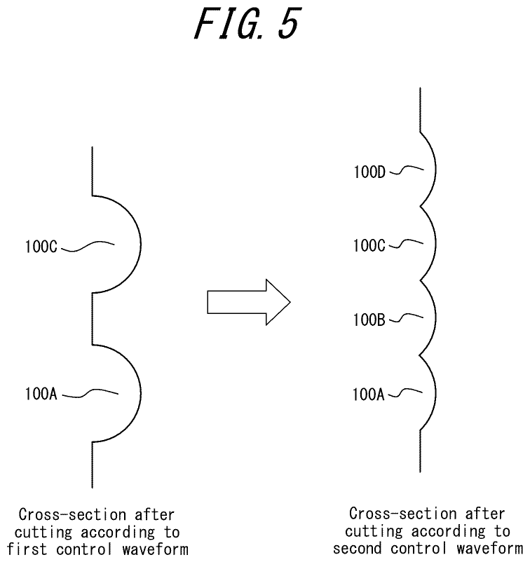

Therefore, in the example illustrated in FIG. 4, the controller 16 moves the cutting blade 12 according to the first control waveform to cut the cutting hole 100A and the cutting hole 100C in the roll 1 (mold base material) to a predetermined depth as illustrated in FIG. 5. Subsequently, the signal generator 15 moves the cutting blade 12 according to the second control waveform to cut the cutting hole 100B and the cutting hole 100D in the roll 1 (mold base material) to a predetermined depth as illustrated in FIG. 5. The controller 16 repeats cutting according to the first control waveform and the second control waveform until a plurality of cutting holes 100 (cutting holes 100A, 100B, 100C, 100D) aligned in the cutting direction reach the depth indicated by the corresponding gradation signals.

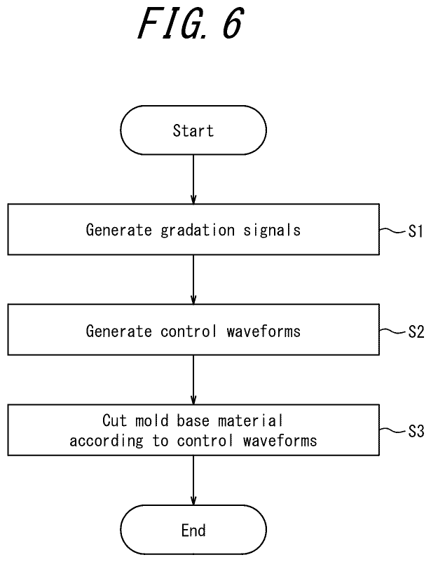

Next, operations of the mold production device 10 according to the present embodiment are described. FIG. 6 is a flowchart illustrating an example of operations of the mold production device 10 according to the present embodiment and is a diagram for explaining a mold production method using the mold production device 10.

The signal generator 15 generates a gradation signal corresponding to each cutting hole 100 in a plurality of cutting holes 100 configuring a drawing target on a mold base material (roll 1), the gradation signal indicating the arrangement and the depth of the cutting hole 100 (step S1).

Next, the signal generator 15 generates, based on gradation signals corresponding to the cutting holes 100, a control waveform indicating a movement pattern of the cutting blade 12 to cause the cutting blade 12 to reciprocate at cutting points of the cutting holes 100 (step S2). Here, the signal generator 15 generates a control waveform for each group in a plurality of groups of cutting holes 100 that do not overlap each other among the plurality of cutting holes 100 aligned in one direction, based on the gradation signals corresponding to the cutting holes 100 constituting each group. In the example illustrated in FIG. 4, the signal generator 15 generates a first control waveform indicating the movement pattern of the cutting blade 12 based on the gradation signals corresponding to the cutting hole 100A and the cutting hole 100C. The signal generator 15 also generates a second control waveform indicating the movement pattern of the cutting blade 12 based on the gradation signals corresponding to the cutting hole 100B and the cutting hole 100D.

The controller 16 moves the cutting blade 12 according to the control waveforms to cut the mold base material (roll 1) (step S3). Here, the controller 16 moves the cutting blade 12 according to each of the plurality of control waveforms generated for the groups to cut the mold base material (roll 1) to a predetermined depth. In the example illustrated in FIG. 4, the controller 16 moves the cutting blade 12 according to the first control waveform to cut the positions corresponding to the cutting hole 100A and the cutting hole 100C to a predetermined depth. Subsequently, the controller 16 moves the cutting blade 12 according to the second control waveform to cut the positions corresponding to the cutting hole 100B and the cutting hole 100D to a predetermined depth.

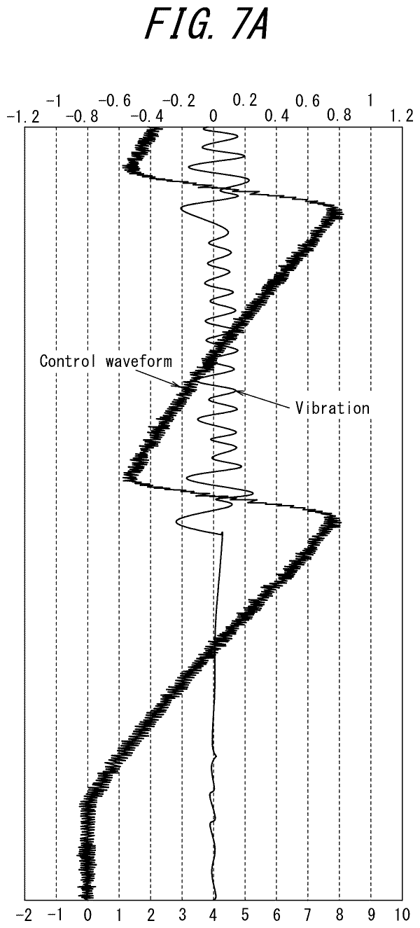

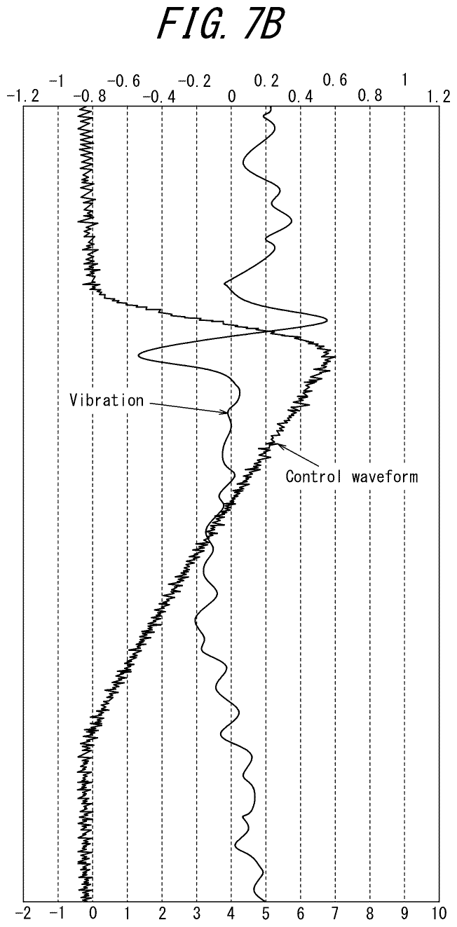

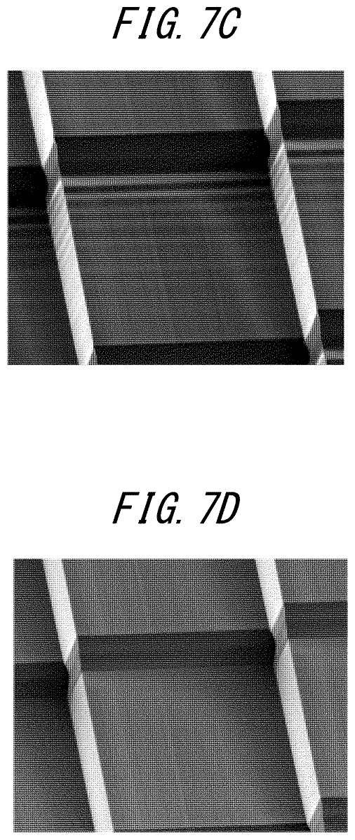

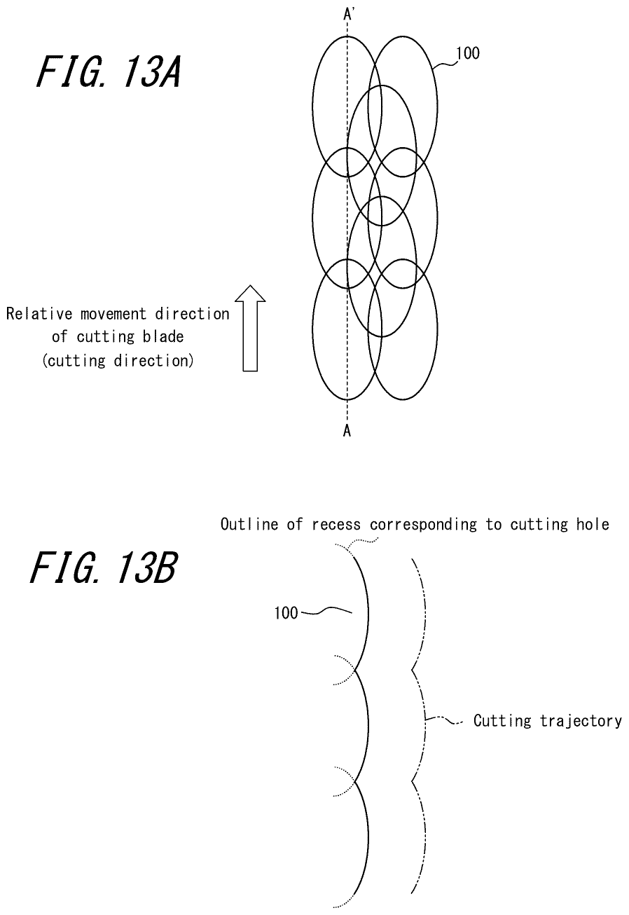

FIG. 7A is a diagram illustrating the control waveform in the case of continuously cutting the cutting holes that overlap each other, as illustrated in FIG. 13B, and the vibration generated in the mold base material in the case of cutting according to this control waveform. FIG. 7B is a diagram illustrating the control waveform in the case of cutting so as not to continuously cut the cutting holes that overlap each other, as in the present embodiment, and the vibration generated in the mold base material in the case of cutting according to this control waveform. FIG. 7C is a Scanning Electron Microscope (SEM) image of the surface of the mold base material cut according to the control waveform illustrated in FIG. 7A. FIG. 7D is an SEM image of the surface of the mold base material cut according to the control waveform illustrated in FIG. 7B. FIGS. 7A and 7B illustrate the case in which the control waveform is a triangular waveform, i.e., the case in which cutting holes with a triangular shape in a cross-sectional view are cut.

As illustrated in FIGS. 7A and 7B, in the case of continuously cutting the cutting holes that overlap each other, fine vibrations with low amplitude and a short period were generated in the mold base material as compared to the case of not continuously cutting the cutting holes that overlap each other. When such fine vibrations are generated, the tracking ability of the FTS degrades. As a result, as illustrated in FIG. 7C, stripe-like shape abnormalities were observed on the surface of the mold base material cut according to the control waveform illustrated in FIG. 7A. On the other hand, as illustrated in FIG. 7B, the generation of fine vibration is suppressed in the present embodiment, thereby suppressing the shape abnormalities and enabling production of a mold such that a plurality of cutting holes 100, among which cutting holes 100 aligned in the cutting direction partially overlap each other, is cut in the mold base material with higher precision. Therefore, as illustrated in FIG. 7D, no shape abnormality like the one illustrated in FIG. 7C was observed on the surface of the mold base material that was cut according to the control waveform illustrated in FIG. 7B.

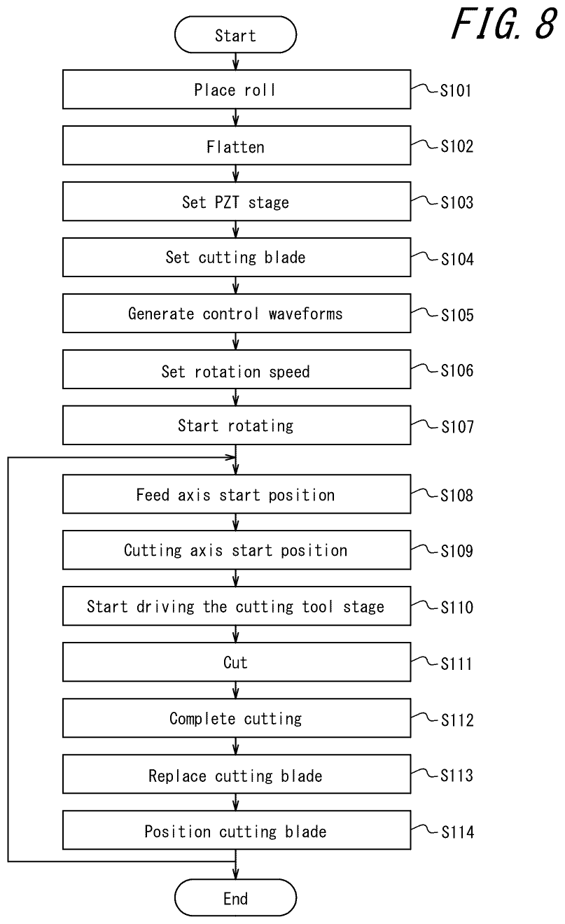

FIG. 8 is a flowchart illustrating a specific example of operations of the mold production device 10 according to the present embodiment.

First, the roll 1 is placed on the rotation device 11 (step S101).

Next, the roll 1 is subjected to flattening processing to flatten the plating layer on the surface of the roll 1 (step S102).

Next, the PZT stage 13 is set on the cutting tool stage 14 (step S103).

Next, the cutting blade 12 is set on the PZT stage 13 (step S104).

Next, control waveforms are generated by the signal generator 15 (S105). As described above, a plurality of control waveforms is generated so that a plurality of cutting holes 100 that partially overlap each other are not cut continuously.

Next, the rotation speed of the rotation device 11 is set (step S106), and the rotation device 11 starts rotating the roll 1 at the set rotation speed (step S107).

Next, the position of the cutting tool stage 14 is set to the start position in the feed axis direction and the start position in the cutting axis direction (steps S108 and S109), and the cutting tool stage 14 starts driving (step S110).

The roll 1 is cut by the cutting tool stage 14 moving according to the gradation signals generated by the signal generator 15 and the cutting blade 12 reciprocating in the radial direction of the roll 1 according to the control waveforms generated by the signal generator 15 (step S111). Details of the cutting of the roll 1 according to the control waveforms are described below.

Once the cutting tool stage 14 moves to the end position in the feed axis direction, cutting is completed (step S112).

In a case in which the cutting blade 12 is worn and needs to be replaced, the cutting blade 12 is replaced (step S113) and positioned (step S114), after which steps S108 through S114 are repeated.

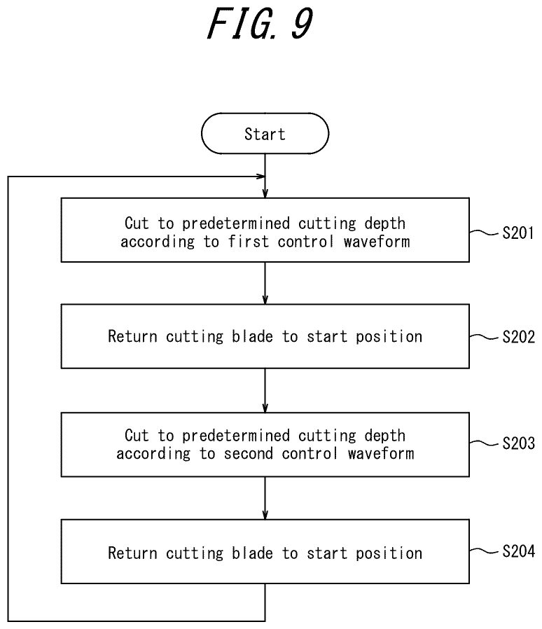

FIG. 9 is a flowchart illustrating details of cutting of the roll 1 according to the control waveforms. In FIG. 9, the case of cutting the roll 1 according to the first control waveform and the second control waveform illustrated in FIG. 4 is described as an example.

In the present embodiment, when cutting the cutting hole 100 to the depth indicated in the gradation signal, the hole is cut multiple times. Therefore, the cutting depth in one cut is less than the depth of the cutting hole 100 indicated in the gradation signal. If a large amount of the mold base material is cut at once, protrusions called burrs may occur. By cutting the cutting hole 100 multiple times as in the present embodiment, the cutting depth per cut is smaller and burrs can be suppressed.

First, the controller 16 moves the cutting blade 12 according to the first control waveform to cut the mold base material to a predetermined depth (step S201). The cutting depth of the mold base material is less than the depth of the cutting holes 100 (cutting holes 100A and 100C) indicated in the gradation signals.

Once cutting is completed to the end position of cutting in the feed axis direction, the controller 16 returns the cutting blade 12 to the start position in the cutting axis direction and the feed axis direction (step S202).

Next, the controller 16 moves the cutting blade 12 according to the second control waveform to cut the mold base material to a predetermined depth (step S203). The cutting depth of the mold base material is less than the depth of the cutting holes 100 (cutting holes 100B and 100D) indicated in the gradation signals.

Once cutting is completed to the end position of cutting in the feed axis direction, the controller 16 returns the cutting blade 12 to the start position in the cutting axis direction and the feed axis direction (step S204) and returns to the process of step S201. The controller 16 repeats the process from step S201 to step S204 until the depth of the plurality of cutting holes 100 (cutting holes 100A, 100B, 100C, 100D) reaches the depth indicated in the gradation signals. In this way, the controller 16 repeats the cutting of the mold base material according to the first control waveform and the cutting of the mold base material according to the second control waveform until the depth of each of the plurality of cutting holes 100 reaches the depth indicated by the corresponding gradation signal. In this way, the cutting depth per cut can be reduced and burr generation can be suppressed.

The mold production method according to the present embodiment thus includes a signal generation step (step S1) of generating a gradation signal corresponding to each cutting hole 100 in the plurality of cutting holes 100 configuring a drawing target on a mold base material (roll 1), the gradation signal indicating an arrangement and a depth of the cutting hole 100, a control waveform generation step (step S2) of generating, based on gradation signals corresponding to the cutting holes 100, a control waveform indicating a movement pattern of the cutting blade 12 to cause the cutting blade 12 to reciprocate at cutting points of the cutting holes 100, and a cutting step (step S3) of moving the cutting blade 12 according to the control waveform to cut the mold base material. In the control waveform generation step, a control waveform is generated for each group in a plurality of groups of cutting holes 100 that do not overlap each other among the plurality of cutting holes 100 aligned in one direction (the cutting direction), based on the gradation signals corresponding to the cutting holes 100 constituting each group. In the cutting step, the cutting blade 12 is moved according to each of the plurality of control waveforms generated for the groups to cut the mold base material to a predetermined depth.

The mold production device 10 according to the present embodiment includes the cutting blade 12 capable of reciprocating in a direction perpendicular to a mold base material (roll 1) and capable of moving relatively in at least one direction along a cutting surface of the mold base material, a signal generator 15 that generates a gradation signal corresponding to each cutting hole 100 in a plurality of cutting holes 100 configuring a drawing target on the mold base material, the gradation signal indicating an arrangement and a depth of the cutting hole 100, and generates, based on gradation signals corresponding to the cutting holes 100, a control waveform indicating a movement pattern of the cutting blade 12 to cause the cutting blade 12 to reciprocate at cutting points of the cutting holes 100, and a controller 16 that moves the cutting blade 12 according to the control waveform to cut the mold base material. The signal generator 15 generates a control waveform for each group in a plurality of groups of cutting holes 100 that do not overlap each other among the plurality of cutting holes 100 aligned in one direction, based on the gradation signals corresponding to the cutting holes 100 constituting each group. The controller 16 moves the cutting blade 12 according to each control waveform in a plurality of control waveforms generated for the groups to cut the mold base material to a predetermined depth.

By cutting according to the control waveform generated for each group of cutting holes 100 that do not overlap each other, it is possible to suppress the generation of fine vibrations in the mold base material compared to when the cutting holes 100 that overlap each other are cut continuously. As a result, according to the mold production method and mold production device 10 of the present disclosure, the occurrence of shape abnormalities is suppressed, enabling production of a mold such that a plurality of cutting holes 100, among which cutting holes 100 aligned in the cutting direction partially overlap each other, is cut in the mold base material with higher precision.

### EXAMPLES

Next, Examples and Comparative Examples are provided to illustrate the present disclosure in more detail, but the present disclosure is not limited to the Examples below.

### Example 1

A roll of SUS304 with a copper-plated surface was prepared. The diameter of the roll was 130 mm and the length of the roll was 250 mm.

Next, the prepared roll was placed on the mold production device according to the present embodiment, and the copper plating layer on the roll surface was flattened. After flattening, the roll was cut to form cutting holes. The cutting blade used was a diamond-tipped cutting blade having a tip radius of 0.02 mm and a circular shape when viewed from the front.

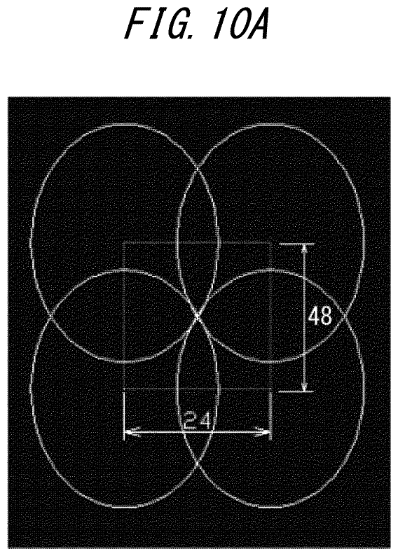

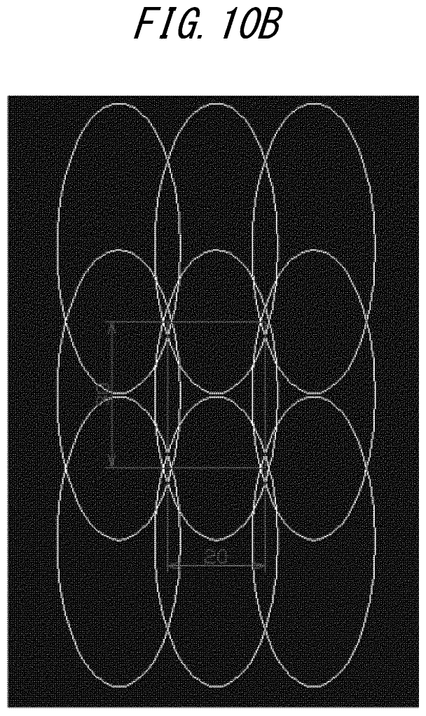

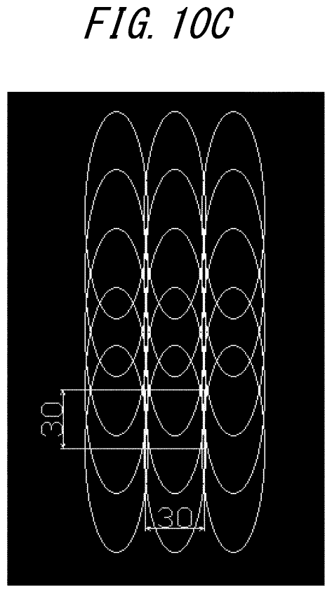

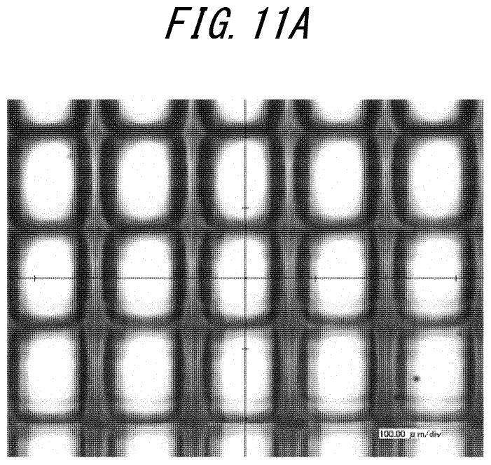

In the present example, cutting holes with a circumferential curvature of 30 μm and a widthwise curvature of 20 μm were arranged in a square at a pitch of 48 μm in the circumferential direction and a pitch of 24 μm in the width direction, as illustrated in FIG. 10A. The depth of the cutting holes was 7.5 μm. One cut with a cutting depth of 3 μm, four cuts with a cutting depth of 1 μm, and one cut with a cutting depth of 0.5 μm were made. The control waveform was a waveform in which the radius of curvature of the cutting path in the circumferential direction of the roll was 30 μm, and cutting of every other cutting hole was skipped. The roll rotation speed was set to 2 min⁻¹.

### Example 2

In the present example, cutting holes with a circumferential curvature of 100 μm and a widthwise curvature of 20 μm were arranged in a square at a pitch of 30 μm in the circumferential direction and a pitch of 20 μm in the width direction, as illustrated in FIG. 10B. The depth of the cutting holes was 4.5 μm. One cut with a cutting depth of 3 μm, four cuts with a cutting depth of 1 μm, and one cut with a cutting depth of 0.5 μm were made. The control waveform was such that cutting of two cutting holes was skipped. The roll rotation speed was set to 2.5 min⁻¹. Other conditions were the same as in Example 1.

### Example 3

In the present example, cutting holes with a circumferential curvature of 180 μm and a widthwise curvature of 20 μm were arranged in a square at a pitch of 30 μm in the circumferential direction and a pitch of 20 μm in the width direction, as illustrated in FIG. 10C. The depth of the cutting holes was 8 μm. One cut with a cutting depth of 3 μm, one cut with a cutting depth of 2.5 μm, two cuts with a cutting depth of 1 μm, and one cut with a cutting depth of 0.5 μm were made. The control waveform was such that cutting of three cutting holes was skipped. The roll rotation speed was set to 4 min⁻¹. Other conditions were the same as in Example 1.

### Comparative Example 1

In Comparative Example 1, the control waveform was such that adjacent cutting holes were cut continuously. Other conditions were the same as in Example 1.

Next, microlens arrays were produced using the roll molds according to Examples 1 to 3 and Comparative Example 1. The microlens arrays were produced as follows. An uncured acrylic UV curable resin was dropped onto a base material made of polyethylene terephthalate (PET) to form a curable resin layer. Next, the curable resin layer was cured by pressing the produced roll mold onto the formed curable resin layer and irradiating the curable resin layer with UV light in this state. After curing of the curable resin layer, the cured curable resin layer was peeled off from the roll mold to produce a microlens array.

Next, the surfaces of the roll molds according to Examples 1 to 3 and the roll mold according to Comparative Example 1 were observed by microscope. The surfaces of the microlens arrays produced using these roll molds were also observed by SEM.

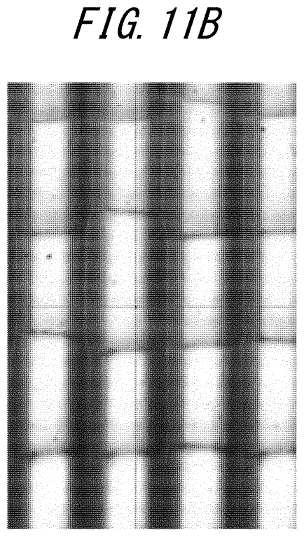

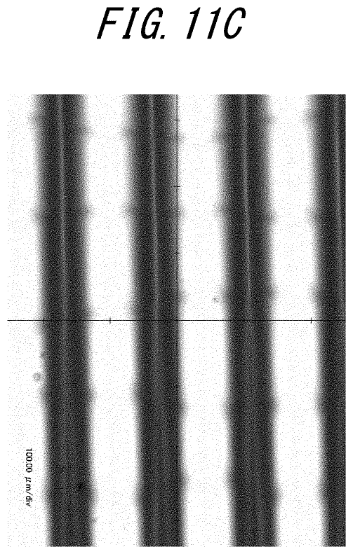

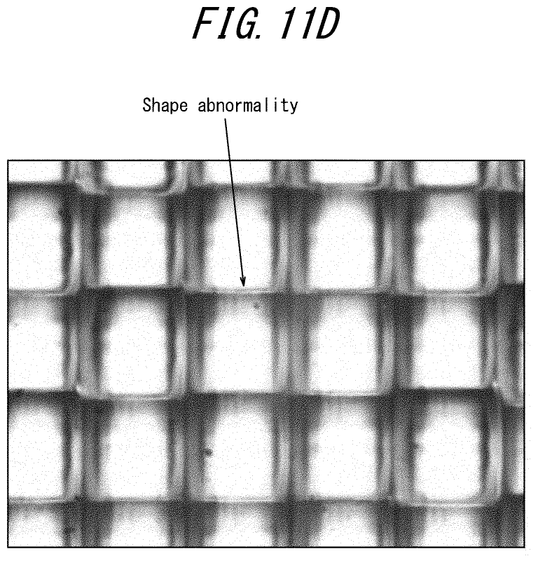

FIG. 11A is a microscope image of the surface of the roll mold according to Example 1. FIG. 11B is a microscope image of the surface of the roll mold according to Example 2. FIG. 11C is a microscope image of the surface of the roll mold according to Example 3. FIG. 11D is a microscope image of the surface of the roll mold according to Comparative Example 1.

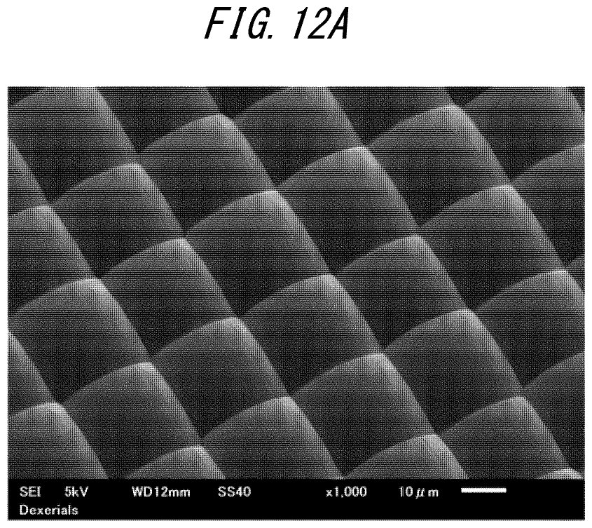

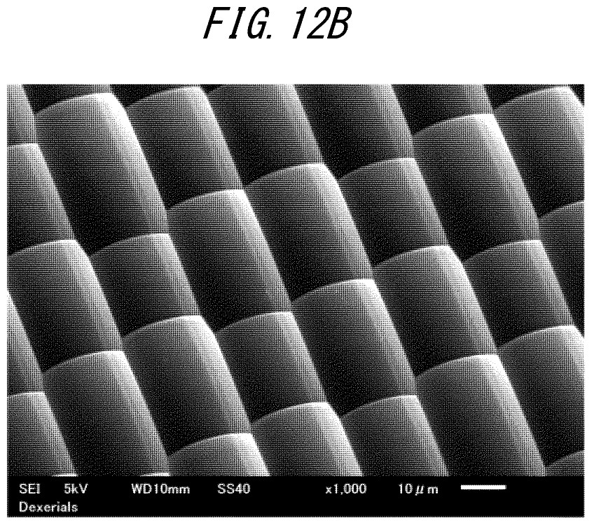

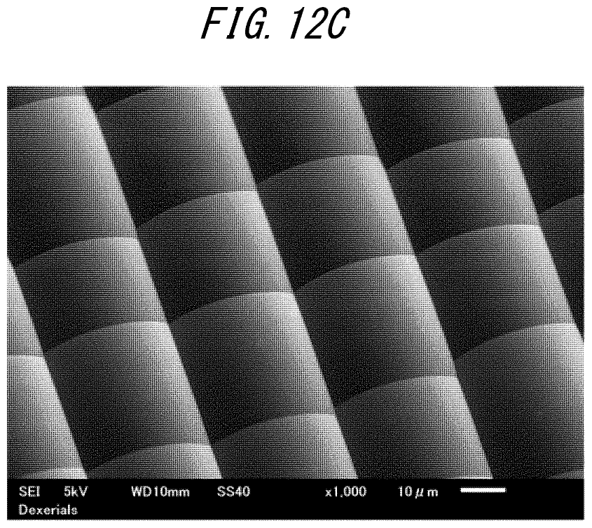

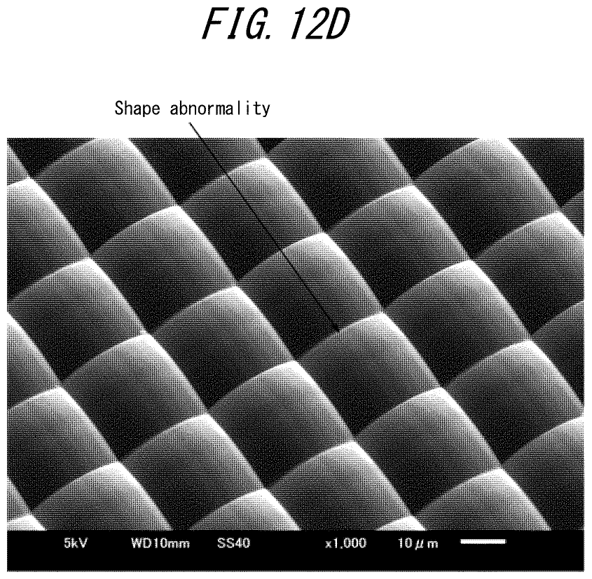

FIG. 12A is an SEM image of the surface of a microlens array produced using the roll mold according to Example 1. FIG. 12B is an SEM image of the surface of a microlens array produced using the roll mold according to Example 2. FIG. 12C is an SEM image of the surface of a microlens array produced using the roll mold according to Example 3. FIG. 12D is an SEM image of the surface of a microlens array produced using the roll mold according to Comparative Example 1.

As illustrated in FIGS. 11A to 11C, no shape abnormality was observed in the roll molds according to Examples 1 to 3. Consequently, no shape abnormality was observed in the microlens arrays produced using the roll molds according to Examples 1 to 3 either, as illustrated in FIGS. 12A to 12C.

On the other hand, as illustrated in FIG. 11D, a shape abnormality was observed near the boundary between adjacent cutting holes in the roll mold according to Comparative Example 1. Consequently, a shape abnormality was also observed in the microlens array produced using the roll mold according to Comparative Example 1, as illustrated in FIG. 12D.

The signal generator 15 and the controller 16 are, for example, configured by a computer provided with a memory and a processor. In a case in which the signal generator 15 and the controller 16 are configured by a computer, the signal generator 15 and the controller 16 are realized by the processor reading and executing a program, according to the present embodiment, stored in the memory.

The program describing the processing to realize each function of the signal generator 15 and the controller 16 may be recorded on a computer-readable recording medium. Using such a recording medium, the program can be installed on a computer. Here, the recording medium on which the program is recorded may be a non-transitory recording medium. The non-transitory recording medium is not limited, and examples thereof include recording media such as a CD-ROM or DVD-ROM.

The present disclosure is not limited to the configurations specified in the above embodiments, and a variety of modifications may be made without departing from the scope of the present disclosure recited in the claims. For example, the functions and the like included in the various components may be reordered in any logically consistent way. Furthermore, components may be combined into one or divided.

REFERENCE SIGNS LIST

| | |
|---|---|
| 10 | Mold production device |
| 11 | Rotation device |
| 11a | Rotary encoder |
| 12 | Cutting blade |
| 13 | PZT stage |
| 14 | Cutting tool stage |
| 15 | Signal generator |
| 16 | Controller |
| 17 | Amplifier |

1. A mold production method using a mold production device comprising a cutting blade capable of reciprocating in a direction perpendicular to a mold base material and capable of moving relatively in at least one direction along a cutting surface of the mold base material, the mold production method comprising:
generating a gradation signal corresponding to each cutting hole in a plurality of cutting holes configuring a drawing target on the mold base material, the gradation signal indicating an arrangement and a depth of the cutting hole;
generating, based on gradation signals corresponding to the cutting holes, a control waveform indicating a movement pattern of the cutting blade to cause the cutting blade to reciprocate at cutting points of the cutting holes; and
moving the cutting blade according to the control waveform to cut the mold base material, wherein
each cutting hole in a plurality of cutting holes aligned in the one direction is arranged to partially overlap with one or more other cutting holes,
a control waveform is generated for each group in a plurality of groups of cutting holes that do not overlap each other among the plurality of cutting holes aligned in the one direction, based on gradation signals corresponding to the cutting holes constituting each group, and
the cutting blade is moved according to each control waveform in a plurality of control waveforms generated for the groups to cut the mold base material to a predetermined depth.

2. The mold production method according to claim 1, wherein cutting of the mold base material according to each control waveform in the plurality of control waveforms is repeated until reaching the depth indicated by the gradation signal corresponding to each cutting hole in the plurality of cutting holes aligned in the one direction.

3. The mold production method according to claim 1, wherein the mold base material is columnar or cylindrical and is held in a circumferentially rotatable manner.

4. The mold production method according to claim 1, wherein the cutting hole has a spherical shape, an aspherical shape, or a substantially rectangular shape.

5. A mold production device comprising:
a cutting blade capable of reciprocating in a direction perpendicular to a mold base material and capable of moving relatively in at least one direction along a cutting surface of the mold base material;
a signal generator configured to generate a gradation signal corresponding to each cutting hole in a plurality of cutting holes configuring a drawing target on the mold base material, the gradation signal indicating an arrangement and a depth of the cutting hole, and generate, based on gradation signals corresponding to the cutting holes, a control waveform indicating a movement pattern of the cutting blade to cause the cutting blade to reciprocate at cutting points of the cutting holes; and
a controller configured to move the cutting blade according to the control waveform to cut the mold base material, wherein
the signal generator is configured to generate a control waveform for each group in a plurality of groups of cutting holes that do not overlap each other among a plurality of cutting holes aligned in the one direction, based on gradation signals corresponding to the cutting holes constituting each group, and
the controller is configured to move the cutting blade according to each control waveform in a plurality of control waveforms generated for the groups to cut the mold base material to a predetermined depth.
